(19) United States
(12) Patent Application Publication
(10) Pub. No.: US 2019/0095956 A1
(43) Pub. Date: Mar. 28, 2019

(54) INFORMATION CONTROL APPARATUS, INFORMATION CONTROL SYSTEM AND INFORMATION CONTROL METHOD

(71) Applicant: FUJITSU LIMITED, Kawasaki-shi (JP)

(72) Inventors: Masafumi Katoh, Yokohama (JP); Naotoshi WATANABE, Yokohama (JP); SATOSHI IMAI, Kawasaki (JP); AKIKO YAMADA, Kawasaki (JP)

(73) Assignee: FUJITSU LIMITED, Kawasaki-shi (JP)

(21) Appl. No.: 16/132,519

(22) Filed: Sep. 17, 2018

(30) Foreign Application Priority Data
Sep. 22, 2017 (JP) 2017-182985

(51) Int. Cl. G06Q 30/02

(52) U.S. Cl. CPC G06Q 30/0269

(57) ABSTRACT

An information control apparatus includes, a memory that stores information relating to content, an acquiring circuit that acquires information relating to a request specified by a third party different from an original source of the content, a determining circuit that determines whether or not to present stored content to a user based on the request, and an output circuit that outputs information relating to content selected to be presented.

### CROSS-REFERENCE TO RELATED APPLICATION

This application is based upon and claims the benefit of priority of the prior Japanese Patent Application No. 2017-182985, filed on Sep. 22, 2017, the entire contents of which are incorporated herein by reference.

### FIELD

The embodiments discussed herein are related to an information control apparatus, an information control system and an information control method.

### BACKGROUND

A so-called context awareness technique in which a provision method of a service is changed according to the surrounding situation (context) around a user is known. For example, a technique is known in which advertisement of a commercial product or service in which a personal profile and the present environment are reflected in real time and that has a high possibility of evoking latent demand of a user is distributed to the user individually on a per user basis without involving a troublesome operation. In this technique, a physical amount of data of a detection target is sensed and the physical amount of data and advertisement content are stored in plural nodes that are connected to a network and each allocated an identification address unique in the network. In this technique, the physical amount of data and the advertisement content are distributed from the node to a terminal that may access the node.

Furthermore, a technique in which a relevant commercial product or service is recommended by using purchase history information and viewed commercial product information is also known. In this technique, one or more pieces of user management information including a user identifier, one or more pieces of purchase history information, and one or more pieces of viewed commercial product information relating to a commercial product seen by a user and two or more pieces of commercial product information including one or more pieces of attribute information are stored. In this technique, the user identifier is received from a terminal apparatus, and all or part of one or more pieces of commercial product information is acquired from a commercial product information storing unit by using one or more pieces of purchase history information and one or more pieces of viewed commercial product information that make a pair with the user identifier, and all or part of one or more pieces of commercial product information is transmitted to the terminal apparatus.

However, in the above-described technique, it is difficult for a third party other than the provision source to control content to be provided to the user. For example, content of advertisement or the like is sent to the consumer by an advertiser or advertisement agent based on an intention of desiring a service of the advertiser to be “used” or “purchased.” However, convenience of the user as the receiver is not considered. In the above-described technique, it is difficult for a third party other than the provision source to control content to be provided to the user in consideration of the convenience of the user and so forth.

Related arts are disclosed in the following documents: Japanese Laid-open Patent Publication No. 2002-109367 and Japanese Laid-open Patent Publication No. 2015-133033.

### SUMMARY

According to an aspect of the embodiments, an information control apparatus includes, a memory that stores information relating to content, an acquiring circuit that acquires information relating to a request specified by a third party different from an original source of the content, a determining circuit that determines whether or not to present stored content to a user based on the request, and an output circuit that outputs information relating to content selected to be presented.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of the relationship between an agent and a request;

FIG. 2 is a diagram illustrating one example of combinations of a concerned party and a target person in embodiment 1;

FIGS. 3A to 3C are diagrams illustrating one example of a profile in embodiment 1;

FIG. 4 is a diagram in which factors that have an influence on an internal context are marshaled;

FIG. 5 is a diagram illustrating one example of change in an internal context;

FIG. 6 is a diagram illustrating one example of the relationship between a profile and an internal context in embodiment 1;

FIG. 7 is a diagram illustrating one example of the relationship between an external context and an internal context in embodiment 1;

FIG. 8 is a diagram illustrating one example of an information control system in embodiment 1;

FIG. 9 is a diagram illustrating one example of a human model in embodiment 1;

FIG. 10 is a sequence diagram illustrating one example of information control processing in embodiment 1;

FIG. 11 is a flowchart illustrating one example of initial setting processing in embodiment 1;

FIG. 12 is a flowchart illustrating one example of information selection processing in embodiment 1;

FIG. 13 is a diagram illustrating one example of transition of an internal context in embodiment 2;

FIG. 14 is a diagram illustrating one example of transition probabilities of an internal context in embodiment 2;

FIG. 15 is a diagram illustrating one example of an information control system in embodiment 3;

FIG. 16 is a diagram illustrating one example of a log database (DB) in embodiment 3;

FIG. 17 is a diagram illustrating one example of the relationship between profile attributes and readily-affecting words in embodiment 3;

FIG. 18 is a diagram illustrating one example of the relationship between contexts and readily-affecting words in embodiment 3;

FIG. 19 is a diagram illustrating one example of the relationship between a difference in an internal context and transition based on information input in embodiment 4;

FIG. 20 is a diagram illustrating one example of the relationship between a stage of needs and transition of an internal context; and

FIG. 21 is a diagram illustrating one example of a computer that executes an information control program.

### DESCRIPTION OF EMBODIMENTS

Embodiments of an information control apparatus, an information control system, and an information control method disclosed by the present application will be described in detail below based on the drawings. This disclosure is not limited by these embodiments. Furthermore, the respective embodiments to be represented below may be combined as appropriate in a range in which contradiction is not caused.

### Embodiment 1

An information control apparatus to be described later in the present embodiment selects and provides content of advertisement or the like to a target person. For example, the information control apparatus executes processing as a substitute (agent) for the target person. A target person is one example of a user and the user will be represented as “target person” in some cases.

When determining whether or not to provide content to a target person, the information control apparatus uses information relating to a request or objective specified by a third party different from the provision source of the content. The third party is a concerned party that may identify the target person and has a certain relationship with the target person, for example, and will be described as a “concerned party” in some cases hereinafter. An example of the concerned party corresponds to a company as an employer of an employee if the target person is the employee, and corresponds to a guardian, cram school, or the like of a student preparing for an examination if the target person is the student. Furthermore, the target person may set information relating to the request or objective instead of the concerned party of the target person.

Any intention of the distribution source may be included in content in many cases. The content distribution source regards a person as one consumer and is discriminated from the concerned party that may identify the individual in the present disclosure. For example, in advertisement content, advertiser's intention desire for an advertised commercial product to be purchased or a service to be used is included. Furthermore, content of the operation status of trains or the like includes an intention to evoke the attention of users. Such intention included in content is set irrespective of the request or objective intended by the target person and it is undesirable that a large amount of content that does not match the request or objective be provided to the target person. However, the present embodiment does not exclude a use scene in which the concerned party that defines the request or objective to the target person corresponds with the content distribution source. In this case, the concerned party may be regarded as the content distributer.

Therefore, independently of such intention included in content, the information control apparatus in the present embodiment sets a request relating to information useful for the target person and provides content determined to meet the request to the target person. For example, the information control apparatus determines whether or not to present content to the target person based on the request specified by the third party different from the provision source of the content. This allows the third party other than the provision source to control the content to be provided to the target person.

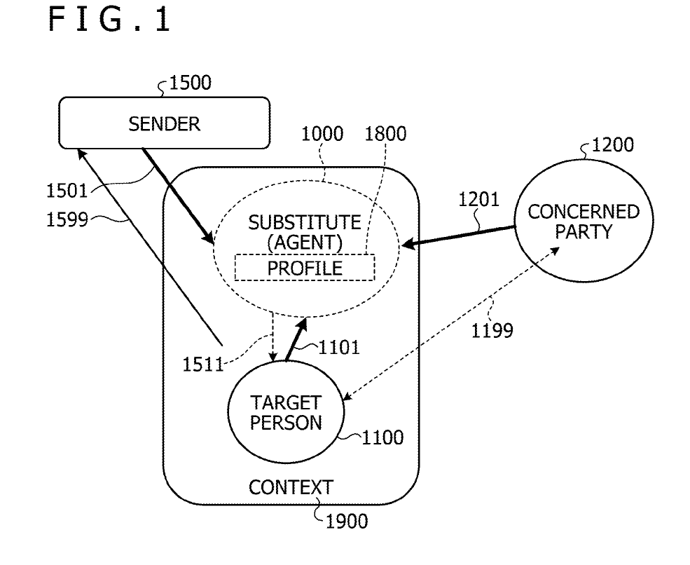

In the present embodiment, description will be made about an example in which an agent executed by the information control apparatus determines whether or not to provide a target person with content provided from a sender such as a service provider based on information relating to a request. The relationship between the content and the information relating to a request in the present embodiment will be described with respect to FIG. 1. FIG. 1 is a diagram illustrating one example of the relationship between an agent and a request. As illustrated in FIG. 1, an agent 1000 in the present embodiment acquires content 1501 from a service provider 1500 and determines whether or not to provide the content 1501 to the target person 1100.

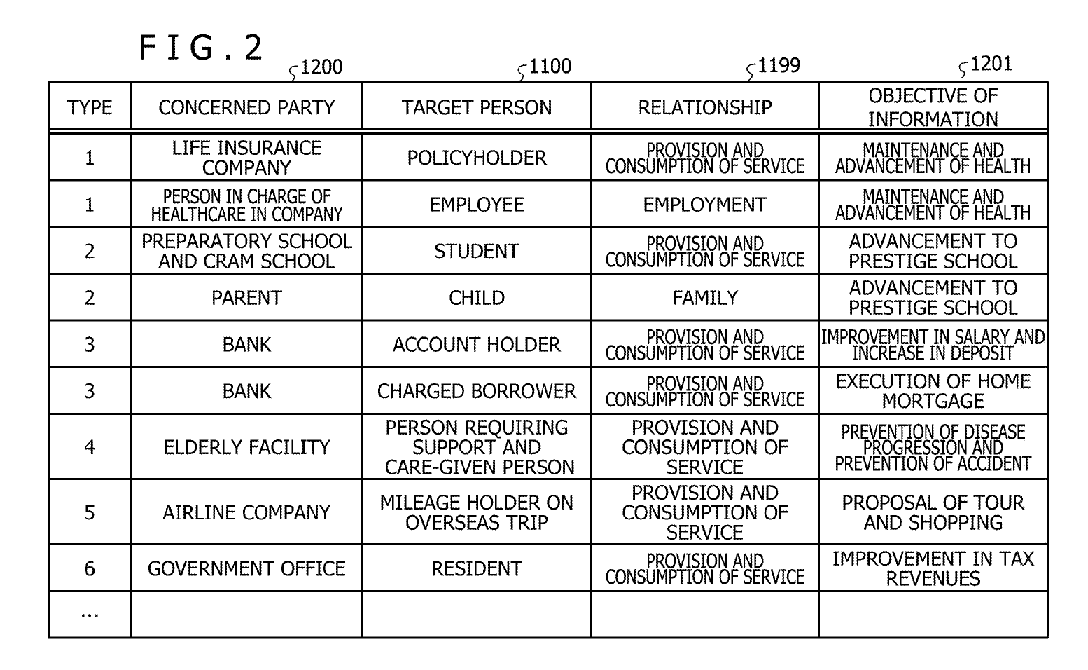

The agent 1000 illustrated in FIG. 1 acquires information 1101 relating to a request from the target person 1100 or information 1201 from a concerned party 1200 having a given relationship 1199 with the target person 1100. FIG. 2 is a diagram illustrating one example of combinations of the concerned party 1200 and the target person 1100 in embodiment 1. The concerned party 1200 is a party having a “relationship” like one represented in FIG. 2 with the target person 1100 and requests the object described in “objective of information” 1201 like one represented in FIG. 2 to the target person1100. The “objective of information” 1201 represented in FIG. 2 is one example of the request specified by the third party different from the original source of content.

Referring again to FIG. 1, the agent 1000 determines whether or not to provide the acquired content 1501 to the target person 1100 based on the acquired request. Then, the agent 1000 presents content 1511 determined to be provided to the target person 1100. If a commercial product or service represented by the content 1511 matches the request, the target person 1100 that has acquired the content 1511 makes an application 1599 for provision of the service or commercial product to the sender 1500.

Furthermore, when determining whether or not to provide the content 1501 to the target person 1100, the agent 1000 in the present embodiment may further use a profile 1800 that represents the individuality of this target person and a context 1900 that represents the situation around the target person.

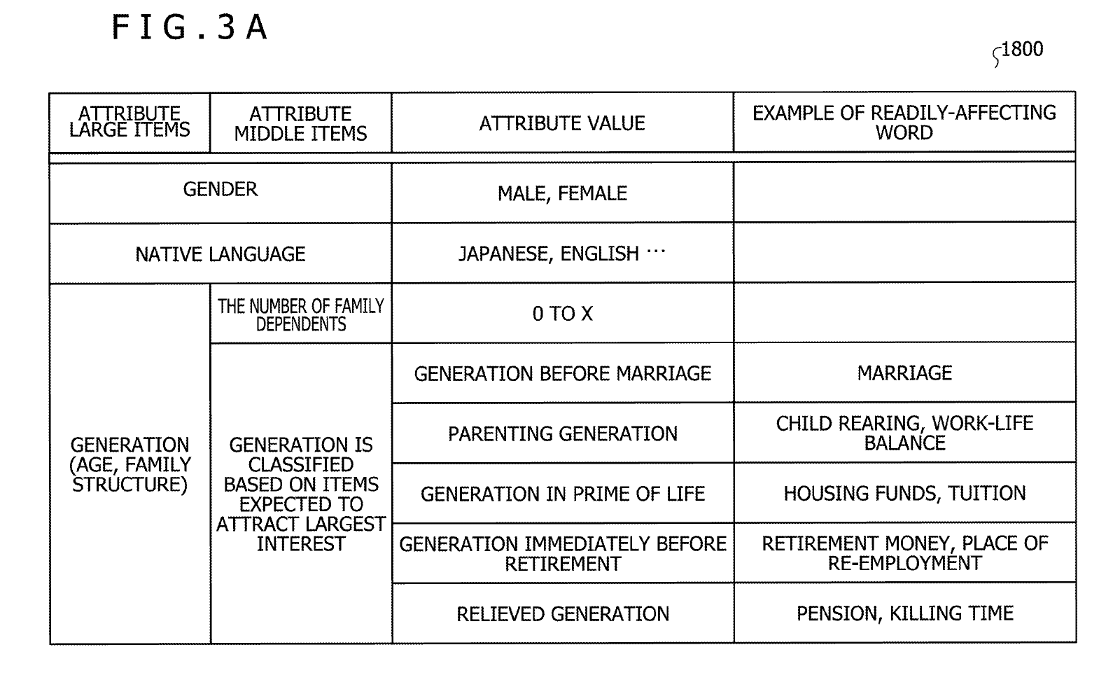

The profile 1800 in the present embodiment includes information relating to the individuality such as personality and values of the target person 1100, for example. Furthermore, in the present embodiment, the individuality of the target person 1100 may include overall attributes formed through accumulation of experiences based on innate personality and abilities, and further includes attributes such as generation, gender, job, income, abilities of the target person, job qualifications, and so forth, for example. FIGS. 3A, 3B, and 3C are diagrams illustrating one example of the profile in embodiment 1. As represented in FIGS. 3A, 3B, and 3C, the profile in the present embodiment includes a wide variety of attributes. However, many attributes in this profile are comparatively-static attributes that are gradually formed over time and do not suddenly change in response to change in the surrounding environment or the physical condition of this person or reception of several pieces of content, or the like.

On the right-end column in FIGS. 3A, 3B, and 3C, words that attract high attention for a collection of people having profile attribute values to be described later are represented. Content including many exemplified words or pieces of information will affect a person having the profile attribute values and cause change in the thought and behavior of the person. This readily-affecting word may be identified by carrying out a questionnaire survey on a large number of people or observing how individuals react to information included in content by a technique of the present disclosure to be described later, and the accuracy thereof may be enhanced.

On the other hand, the context 1900 in the present embodiment is a dynamic thing that varies in a short period of time and is divided into external context and internal context. The external context in the present embodiment is the environment surrounding the target person and changes irrespective of the intention of this target person. For example, temperature, humidity, weather, season, and so forth may be included. Furthermore, the external context may include the location of the target person, the current time, the state of the target person (on duty, in car driving, and so forth) and the state of a service provider (remaining business hours until closing, and so forth), for example. Moreover, the external context may also include the occurrence of an emergency situation, such as the occurrence of a disaster, accident, or other situation.

In the present embodiment, the internal context represents the physical condition and sentiment of the target person oneself. The internal context includes information relating to the physical condition, such as whether the target person is tired or feels fit and whether the target person is sick or healthy, for example. Furthermore, the internal context also includes information relating to the sentiment, such as whether the target person is in good spirits or depressed and whether the target person wants to go home early or wants to act.

Referring back to FIG. 1, the agent 1000 in the present embodiment selects the content 1501 to be provided to the target person 1100 in such a manner that the internal context of the target person changes in such a direction as to match the objective of information. For example, if the information 1201 relating to the request is “maintenance and advancement of health of the target person” and the selected content 1501 is “advertisement of a sports gym,” the agent 1100 selects the content 1501 that causes a change to an internal context of “I go to the gym!” That the internal context becomes more likely to change in such a direction as to match the objective of information due to the content 1501 will be represented as “the content affects the internal context” in some cases hereinafter. Furthermore, providing the content 1501 provided by the sender 1500 to the target person 1100 by the agent 1000 will be represented as “information input” in some cases.

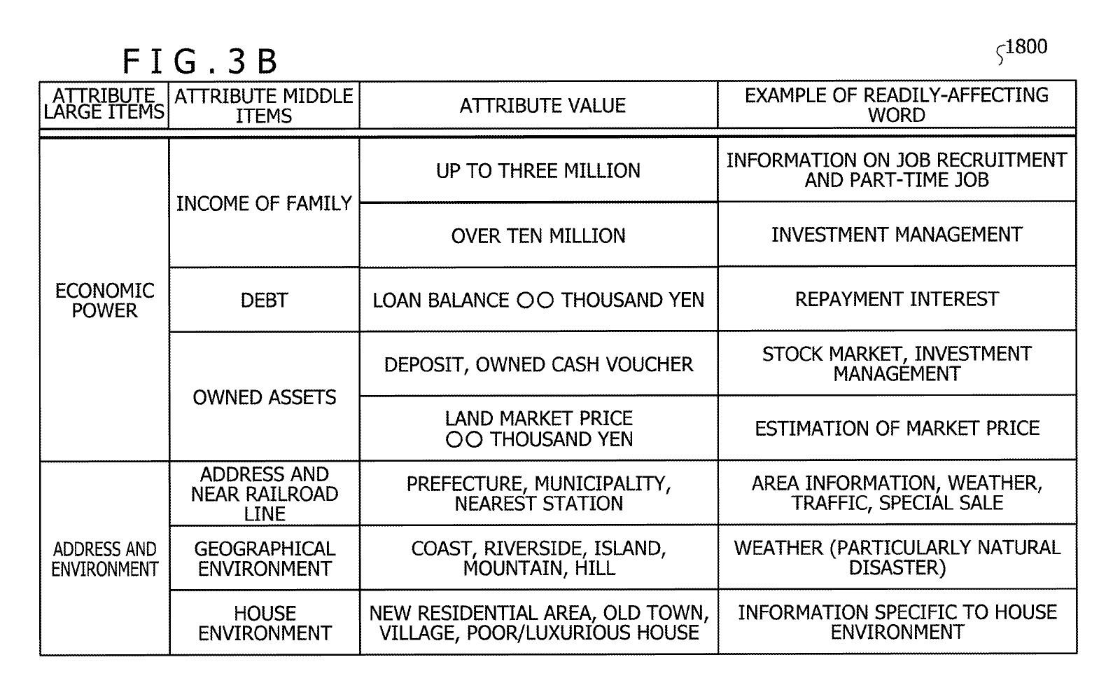

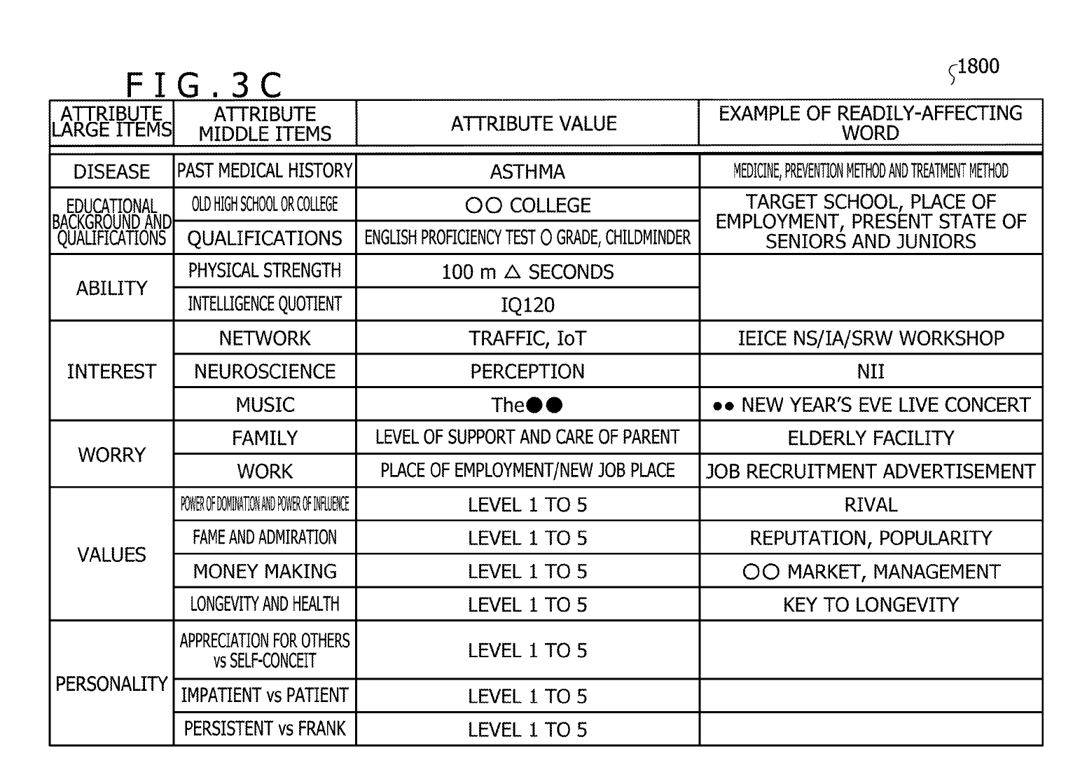

Provision of content and change in the internal context will be described with respect to FIG. 4 and FIG. 5. FIG. 4 is a diagram in which factors that have influence on the internal context are marshaled. Information represented in content is a first factor that changes the internal context. The form of this change differs depending on the external context, which is a second factor. Moreover, the transition of the internal context due to the information input and the external context, which are the first and second factors, is specific to the person. Therefore, it may be said that the transition of the internal context depends on the profile, which is a third factor. In FIG. 4, information and service are described also outside the external context. This represents information and service that are far from the target person or are never possessed by the target person. In the present disclosure, by treating information and service that possibly have influence on the thought and behavior of the target person as the control target, considering the infinite possibility is avoided.

As illustrated in FIG. 4, in the state with a profile 1801 and an external context 1990, the content 1511 is input as information input to internal context A 1901 from a sender 1500. In this case, if the content 1511 is what “affects” internal context A 1901, internal context A 1901 has a high possibility of change to internal context B 1902.

FIG. 5 is a diagram that is based on FIG. 4 and illustrates one example of change in the internal context due to content. As illustrated in FIG. 5, a sender 1590 is a sports gym, for example, and content 1591 includes information of “presently pool is empty,” for example. Furthermore, it is indicated that, if a profile 1811 of the target person 1100 is “health awareness is high” and an external context 1991 is “two hours until closing,” the internal context of the target person 1100 that has received the information input has a high possibility of change from “interested” 1911 to “I go!” 1912.

Even when the same information input is made to the same internal context, the information input does not necessarily “affect” the internal context similarly if the profile or the external context is different. Furthermore, the profile and the external context change in association with the elapse of time and the occurrence of an event.

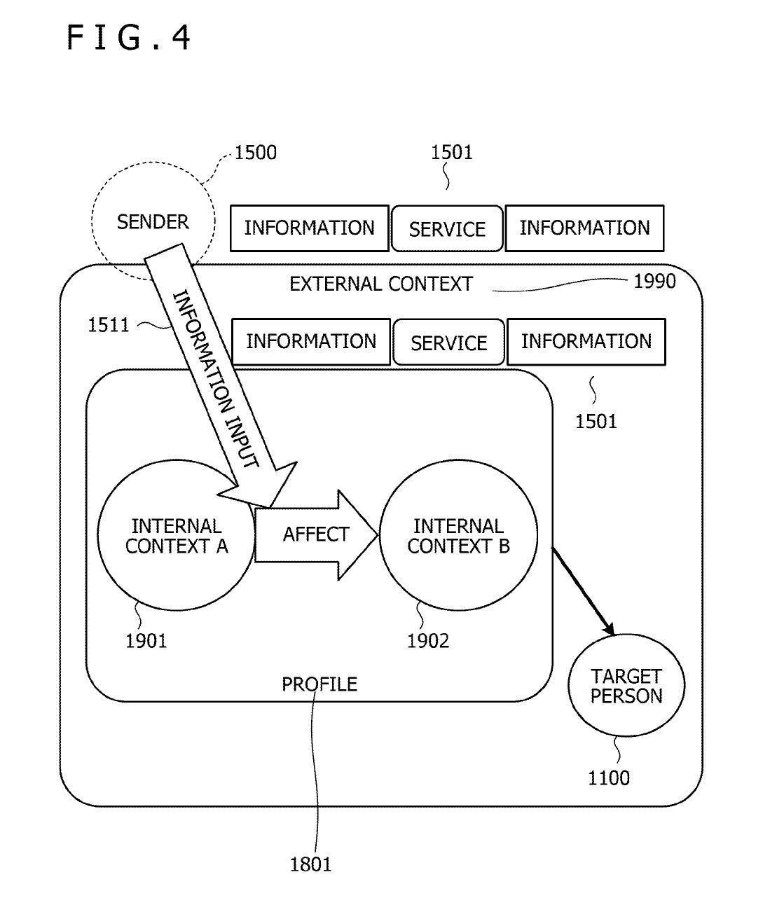

FIG. 6 is a diagram illustrating one example of the relationship between the profile and the internal context in embodiment 1. As illustrated in FIG. 6, if the profile is “health awareness is high” 1811 similarly to the case illustrated in FIG. 5, input of an advertisement of the sports gym “affects” an internal context of “I will go home early” and thereby change to an internal context of “I want to exercise” is readily caused. On the other hand, if the profile is “health awareness is low” 1801, even when input of the like advertisement of the sports gym is made, the possibility that the input of the advertisement affects the internal context of “I will go home early” is low.

Furthermore, as illustrated in FIG. 6, the profile changes due to accumulation of experiences or the lapse of a comparatively-long time. For example, even when the past profile is “health awareness is low” 1801, the profile makes a transition to “health awareness is high” 1811 if “a problem has been found” in the result of a health examination in three consecutive years. Conversely, when the profile is “health awareness is high” 1811 the profile makes a transition to “health awareness is low” 1801 if “a problem has not been found” in the result of a health examination in three consecutive years.

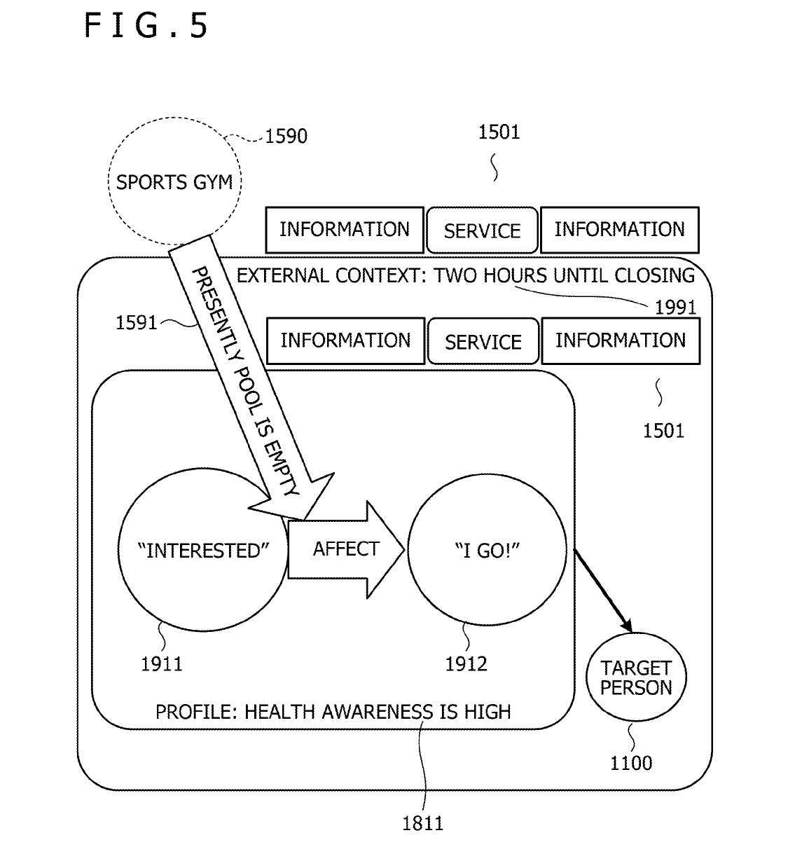

The external context also has influence on the relationship between the internal context and information input similarly to the profile. Furthermore, the external context changes to a different external context in some cases. FIG. 7 is a diagram illustrating one example of the relationship between the external context and the internal context in embodiment 1. For example, description will be made about the case in which information input of “a new machine has been placed in the gym” is made when the internal context is “I will go home early.” As illustrated in FIG. 7, for example, if the external context is “two hours until closing of the gym” 1991 similarly to the case illustrated in FIG. 5, the internal context changes to “I want to exercise” in some cases. On the other hand, for example, if the external context is “ten minutes until closing of the gym” 1992, the possibility that the internal context remains “I will go home early” without change is high.

As above, the information control apparatus selects information input with which the internal context of the target person changes in such a direction as to prompt the target person to make behavior in accordance with the request. Furthermore, change in the internal context is influenced also by the profile of the target person and the external context. Therefore, the information control apparatus may set a human model, which will be described later, that expresses how the internal context makes a transition due to information input according to the set request based on the profile and the external context.

[Functional Blocks]

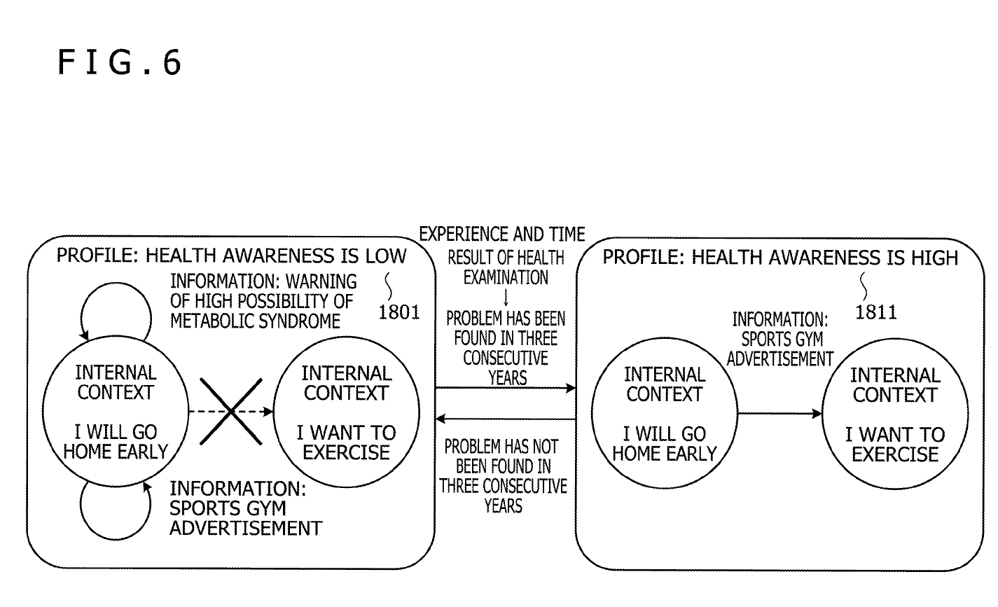

Next, an information control system in the present embodiment will be described with respect to FIG. 8. FIG. 8 is a diagram illustrating one example of the information control system in embodiment 1. An information control system 1 illustrated in FIG. 8 includes an information control apparatus 100, sensors 500a and 500b, an information and communication technology (ICT) server 700, a target person terminal 800, and a concerned party terminal 900. Hereinafter, when being expressed without discrimination, the sensors 500a and 500b will be represented simply as “sensors 500” in some cases.

In the present embodiment, the information control apparatus 100 is coupled to the sensors 500, the ICT server 700, the target person terminal 800, and the concerned party terminal 900 by a wireless or wired network and may carry out communication according to need. For example, the information control apparatus 100 illustrated in FIG. 8 is coupled to the ICT server 700, the target person terminal 800, and the concerned party terminal 900 via the Internet and is coupled to the sensors 500 through a radio communication network.

In FIG. 8, the information control system 1 including two sensors 500, one ICT server 700, one target person terminal 800, and one concerned party terminal 900 is illustrated. However, the embodiment is not limited thereto. For example, a configuration may be employed in which the information control system 1 includes plural ICT servers, target person terminals, and concerned party terminals. Furthermore, a configuration including three or more sensors 500 may be employed. Conversely, a configuration that does not include the sensor 500 may be employed and a configuration in which the information control apparatus 100 includes the sensor 500 may be employed.

The information control apparatus 100 illustrated in FIG. 8 determines whether or not content matches a set request and presents content that matches the request to a target person, for example. The information control apparatus 100 is implemented by a server computer, for example. However, the information control apparatus 100 is not limited thereto and may be implemented at an arbitrary place, such as a node in the target person terminal 800 or a network or cloud device.

The sensors 500 included in FIG. 8 acquire information that serves as the basis of the external context or internal context of the target person. For example, the sensors 500 include a camera that photographs or records video of the surrounding environment of the target person, a microphone that receives sounds, an illuminance sensor, a temperature indicator, and a barometer for identifying the weather, a global positioning system (GPS) sensor that identifies location information of the target person, and so forth. Furthermore, the sensors 500 may include a thermometer, heart rate meter, and electrocardiograph for identifying the health condition of the target person, an accelerometer for identifying the posture and motion of the target person, camera and microphone for detecting the facial expression and sentiment from the complexion and the tone of voice of the target person, a line-of-sight sensor that detects the direction of the line of sight of the target person, and so forth, for example. The sensors 500 may include a clock, timer, or the like that detects the lapse of time.

The ICT server 700 illustrated in FIG. 8 provides content to the target person. The ICT server 700 may be of a company that prompts the target person to purchase a commercial product or use a service or a company that provides advertisement content thereof, for example. Furthermore, the ICT server 700 includes an archive site that stores pictures of sightseeing spots, academic papers, and other documents. Moreover, the ICT server 700 may include a service to provide pieces of public content of traffic information, disaster information, and so forth.

The target person terminal 800 illustrated in FIG. 8 is a terminal operated by a target person, for example. The target person terminal 800 is a portable terminal such as a smartphone, for example. However, the target person terminal 800 is not limited thereto and may be a stationary computer or the like. The target person terminal 800 may be a wearable device such as eyeglasses or a wrist band. The target person terminal 800 presents content output from the information control apparatus 100 to the target person.

The concerned party terminal 900 illustrated in FIG. 8 is a terminal operated by a concerned party having a relationship with a target person like that represented in FIG. 2, for example. The concerned party terminal 900 is a portable terminal such as a smartphone, for example. However, the concerned party terminal 900 is not limited thereto and may be a stationary computer or the like. The concerned party terminal 900 transmits, to the information control apparatus 100, information that defines a request or demand relating to what state the target person is desired to be set to.

Next, one example of the information control apparatus in the present embodiment will be described. As illustrated in FIG. 8, the information control apparatus 100 in the present embodiment includes a communication circuit 110, a memory 120, and a control circuit 130.

The communication circuit 110 controls communication with other computers such as the ICT server 700, the target person terminal 800, and the concerned party terminal 900 irrespective of whether the communication is a wired communication or a wireless communication. The communication circuit 110 is a communication interface or the like such as a network interface card (NIC) and so forth, for example.

The memory 120 stores various kinds of data and so forth such as a program executed by the control circuit 130, for example. Furthermore, the memory 120 includes a content database (DB) 121 and a model DB 122. The memory 120 corresponds to semiconductor memory elements such as random access memory (RAM), read only memory (ROM), and flash memory and storing apparatus such as a hard disk drive (HDD).

The content DB 121 stores candidates for content to be provided to the target person. In the content DB 121, pieces of content of advertisement, traffic information, and so forth that are acquired by an acquiring circuit 131 to be described later and are provided by the ICT server 700 are stored, for example.

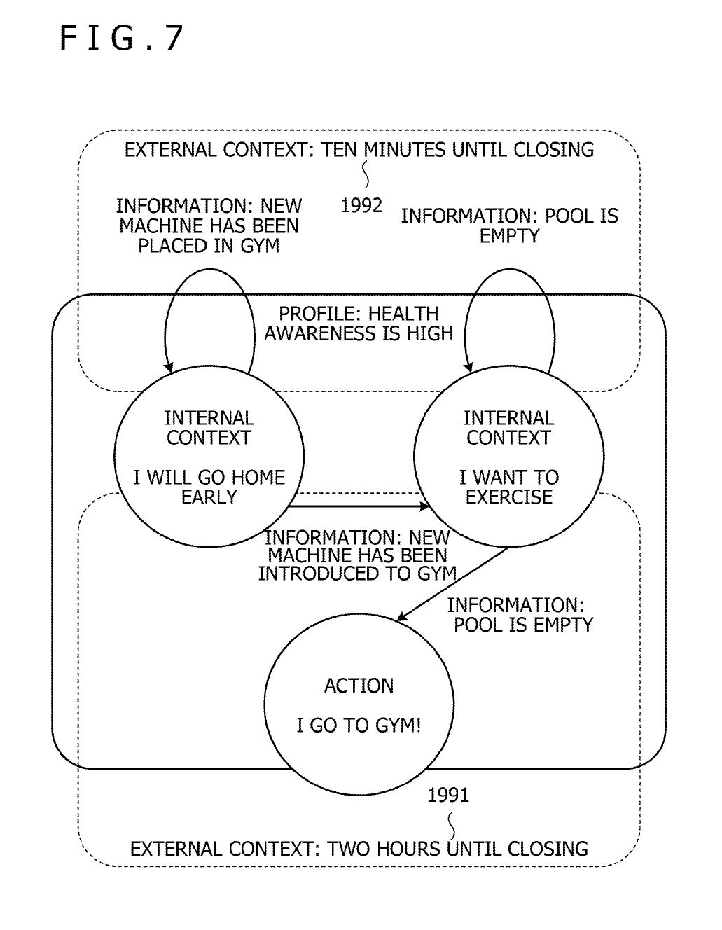

The model DB 122 stores a human model and profiles, external contexts, and internal contexts at the present timing. The information stored in the model DB 122 is input by a setting circuit 132 to be described later. FIG. 9 is a diagram illustrating one example of the human model in embodiment 1.

As illustrated in FIG. 9, a human model 3000 includes plural profiles 3001 and 3002, conditions 3011 and 3012 relating to the transition of the profile, external contexts 3101 and 3102, and internal contexts 3211 to 3222. Furthermore, the human model 3000 further includes information input 3301 and information 3401 relating to the transition of the internal context in association with the information input.

As illustrated in FIG. 9, in the case of the profile 3002 of “health awareness is low,” the internal context does not change from “I will go home early” to “I want to exercise” even when information input of “warning of high possibility of the metabolic syndrome,”“sports gym advertisement,” or the like exists. Furthermore, in the case of the profile 3002 of “health awareness is low”, internal context of “I go to the gym” which leads to actual action by the target person, is not included. On the other hand, in the case of the profile 3001 of “health awareness is high,” the internal context readily changes from “I will go home early” to “I want to exercise” in response to information input 3301 of “you have not yet gone to the gym this month.”

Furthermore, the profiles 3001 and 3002 make a transition due to satisfaction of the condition 3011 or 3012 relating to the transition of the profile. For example, in the case of the profile 3002 of “health awareness is low,” the profile makes a transition to the profile 3001 of “health awareness is high” if the result of a health examination indicating that “a problem has been found” has been received in three consecutive years.

Furthermore, in the case in which information input of “you will make it to a lesson by a favorite instructor” 1511 is made, the possibility of change in the internal context is low if the external context is “ten minutes until closing.” On the other hand, if the external context is “two hours until closing,” the possibility that the internal context changes from “I want to exercise” to “I go to the gym!” is high.

As above, the human model 3000 includes internal contexts different from each other and conditions relating to the transition of the internal context according to profiles or according to external contexts.

Referring back to FIG. 8, the control circuit 130 is a processing unit responsible for overall processing of the information control apparatus 100. The control circuit 130 is implemented through execution of a program stored in an internal storing apparatus by a central processing unit (CPU), micro processing unit (MPU), or the like with use of a RAM as a work area, for example. Furthermore, the control circuit 130 may be implemented by an integrated circuit such as an application specific integrated circuit (ASIC) or field programmable gate array (FPGA), for example.

The control circuit 130 includes the acquiring circuit 131, the setting circuit 132, an update circuit 133, a determining circuit 134, and an output circuit 135. The acquiring circuit 131, the setting circuit 132, the update circuit 133, the determining circuit 134, and the output circuit 135 are one example of an electronic circuit possessed by a processor and one example of a process executed by the processor.

The acquiring circuit 131 acquires information on content, information relating to the request of the target person, information relating to the profile, and sensor information. For example, the acquiring circuit 131 acquires the information relating to content from the ICT server 700 through the communication circuit 110 and stores the information in the content DB 121. Furthermore, the acquiring circuit 131 acquires the information relating to the request of the target person from the concerned party terminal 900 and outputs the information to the setting circuit 132. The acquiring circuit 131 acquires information relating to attributes of the profile from the target person terminal 800 or the concerned party terminal 900 and outputs the information to the setting circuit 132 and the update circuit 133. Moreover, the acquiring circuit 131 acquires various kinds of sensor information detected by the sensors 500 and outputs the sensor information to the setting circuit 132 and the update circuit 133.

In the case of acquiring the information relating to attributes of the profile from the concerned party terminal 900, the acquiring circuit 131 may acquire attributes of the target person perceived by the relevant concerned party and additionally acquire attributes from the target person terminal 800 if a lack of attribute exists. Furthermore, the acquiring circuit 131 may acquire information from another computer different from the target person terminal 800 or the concerned party terminal 900. For example, it becomes possible to acquire an interest profile that represents what kinds of things the target person takes an interest in from the history of access to services with which communication is possible via the Internet.

Next, the setting circuit 132 sets profiles, external contexts, and internal contexts and a human model including these profiles, external contexts, and internal contexts. When acquiring the information relating to the request of the target person from the acquiring circuit 131, the setting circuit 132 sets the internal context that reaches realization of the request of the target person. Then, the setting circuit 132 generates the human model including the transition of the internal context according to the profile and the external context and stores the human model in the model DB 122.

Next, the update circuit 133 updates a profile, external context, or internal context based on information relating to a change in the profile, external context, and internal context. When acquiring new information that will cause an update of the profile, such as the result of a health examination represented in FIG. 9, for example, from the target person terminal 800 or the concerned party terminal 900, for example, the update circuit 133 refers to the model DB 122 and changes the present profile of the target person.

Furthermore, for example, when acquiring location information indicating that the target person has moved, information indicating the lapse of time, or the like from the sensor 500 through the acquiring circuit 131, the update circuit 133 refers to the model DB 122 and changes the present external context of the target person. Similarly, for example, when acquiring information on a change in the heart rate and body temperature of the target person or the like from the sensor 500, the update circuit 133 refers to the model DB 122 and detects a change in the present internal context of the target person.

The information for detecting a change in the internal context is not limited thereto. For example, when content is transmitted to the target person terminal 800, the update circuit 133 detects a response to this content by the target person. For example, if it is detected that the target person has viewed the title and sender of this content and discarded the content without opening the content or after five seconds from opening the content in the target person terminal 800, the update circuit 133 determines that the target person is “uninterested” in this content. On the other hand, if the target person has opened this content and viewed the content for five seconds or longer in the target person terminal 800, for example, the update circuit 133 determines that the target person is “interested” in this content. Then, the update circuit 133 determines whether or not the internal context has changed based on this determination result.

Next, the determining circuit 134 refers to the human model and determines whether or not to output content to the target person. If content is output to the target person, for example, the determining circuit 134 determines whether or not this content “affects” the present internal context of the target person. For example, the determining circuit 134 calculates the “degree of affecting” of this content and determines whether or not this degree of affecting is equal to or higher than a given threshold. If the “degree of affecting” is equal to or higher than the given threshold, the determining circuit 134 determines to output this content to the target person.

Furthermore, the determining circuit 134 may change the timing of output of content according to the external context and internal context of the target person. For example, the determining circuit 134 does not output content relating to a hobby immediately if the external context of the target person is “on duty” and may output the content at a time when the external context has become “during going home.” Conversely, it is also possible for the determining circuit 134 to suppress output of content relating to work if the external context of the target person is “on holiday.”

Next, the output circuit 135 outputs content determined to be output in the determining circuit 134. The output circuit 135 outputs information on the content determined to be output to the target person terminal 800 through the communication circuit 110, for example.

Furthermore, the output circuit 135 may change the output form of content according to at least any one or a plurality of profile, external context, and internal context of the target person. For example, the output circuit 135 may translate the language of text content and change the tone of the words, such as choice of words and Japanese kana orthography. Furthermore, the output circuit 135 may convert text content to voice and conversely convert voice content to text, for example.

For example, if the language of content is not the native language of the target person registered in the profile, the output circuit 135 may output the content after translating the content. Furthermore, if that the target person is an “infant” or “elementary school student” as registered in the profile, the output circuit 135 may turn Japanese kanji characteristics included in content to Japanese hiragana characteristics or give Japanese ruby characteristics (furigana).

Furthermore, if content includes voice, the output circuit 135 may output the content after converting the voice to text when the target person is a hearing-impaired person as registered in the profile or when the voice is difficult to hear, such as when the external context of the target person is “in a crowd.” Conversely, if content includes text, the output circuit 135 may output the content after converting the text context to voice when it is undesirable to move the line of sight, such as when the external context of the target person is “in car driving.”

Moreover, for example, in the case of outputting content that prompts the target person who is a student preparing for an entrance examination to take a test, the output circuit 135 may change the tone of the words of the content according to the internal context of the target person. For example, when the target person is depressed, the output circuit 135 may convert the tone of the words to cause the target person to get confident, like “if you do this, you may increase the score by 10 points on the next test.” Furthermore, when the target person is doing well, the output circuit 135 may convert the tone of the words to caution the target person about overconfidence, like “you had better take a test again because you tend to make a mistake.”

[Flow of Processing]

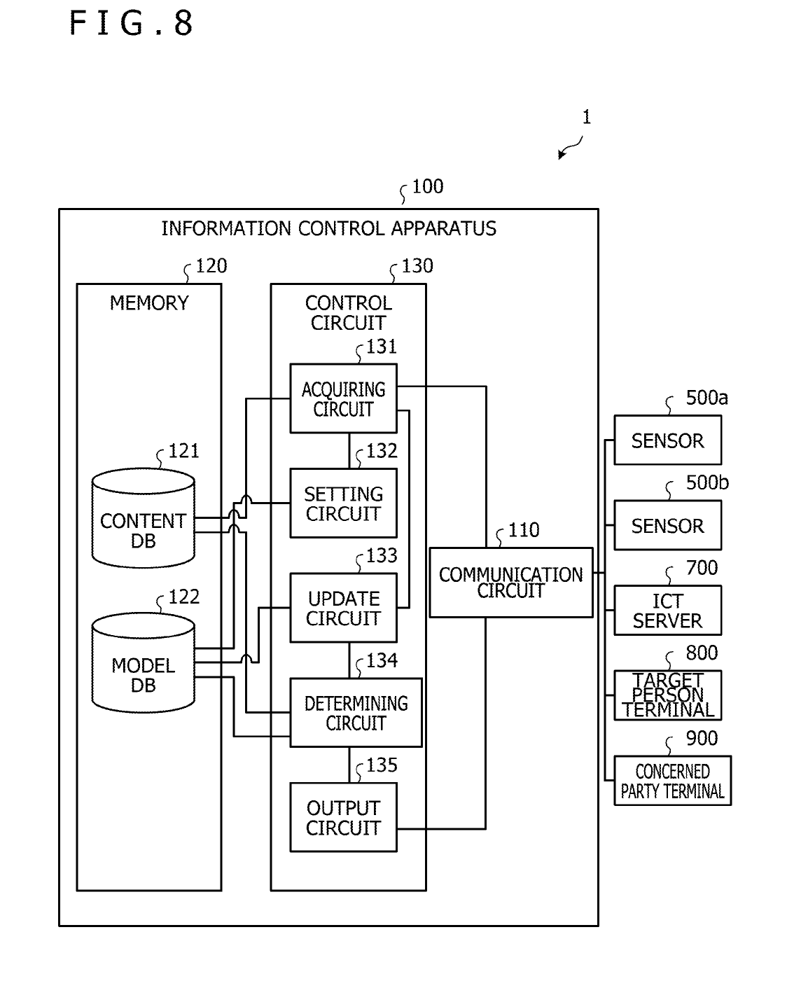

Next, processing in the present embodiment will be described by using FIG. 10 to FIG. 12. FIG. 10 is a sequence diagram illustrating one example of information control processing in embodiment 1. As represented in FIG. 10, the information control apparatus 100 accepts input of an objective from the concerned party terminal 900, for example (S1). Furthermore, the information control apparatus 100 accepts input of information on attributes and so forth relating to setting of a profile from the concerned party terminal 900, for example (S2). Then, the information control apparatus 100 defines a human model including an internal context that matches the input objective (S10).

Next, the information control apparatus 100 acquires data relating to the profile from the target person terminal 800 (S11) and updates the profile (S12). Thereafter, the information control apparatus 100 acquires content from the ICT server 700 (S20).

The information control apparatus 100 refers to the human model and evaluates the “degree of affecting” of the acquired content (S21). The information control apparatus 100 stores information in which it has been determined that the degree of affecting is equal to or higher than a given threshold in the content DB 121 (S22).

Furthermore, the information control apparatus 100 accepts input of information relating to an external context from the target person terminal 800 (S30) and updates the external context (S31). Then, the information control apparatus 100 outputs content accumulated in the content DB 121 to the target person terminal 800 (S32).

Thereafter, when an action such as a purchase of a commercial product or use of a service occurs between the target person and the ICT server 700 (S40), the target person terminal 800 outputs information indicating that the internal context has changed to the information control apparatus 100 (S41). The information control apparatus 100 updates the profile according to the internal context that has changed in some cases (S42). Then, the information control apparatus 100 reports the occurrence of the action by the target person to the concerned party terminal 900 (S43).

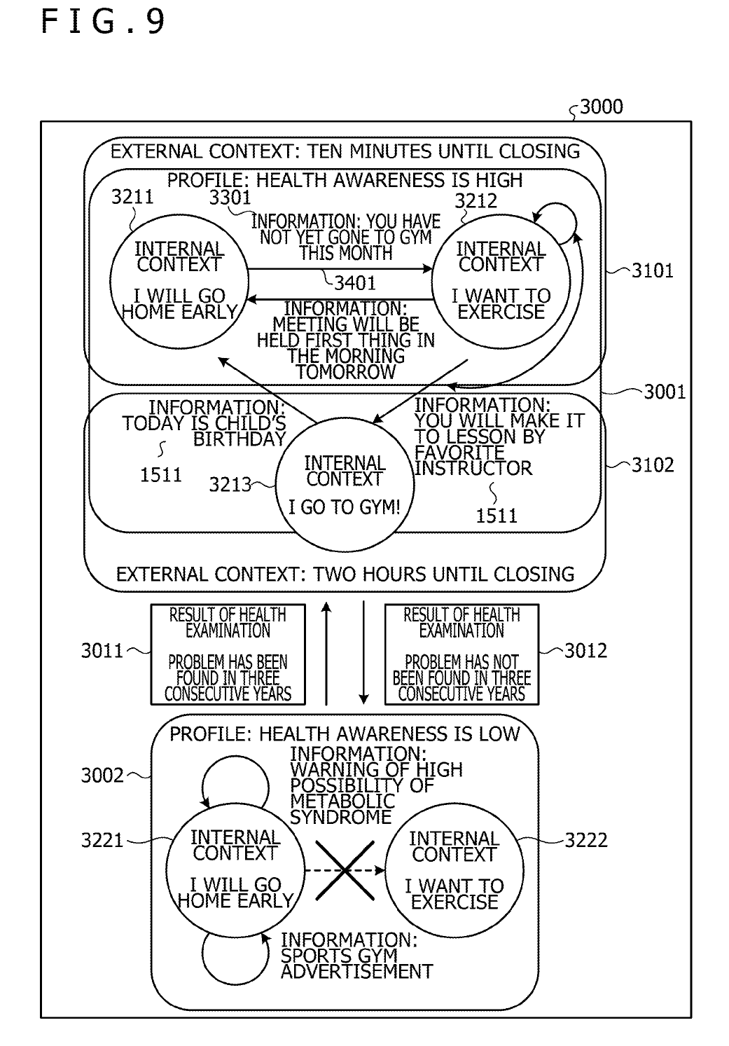

Next, initial setting processing in the present embodiment will be described. FIG. 11 is a flowchart illustrating one example of the initial setting processing in embodiment 1. As represented in FIG. 11, the acquiring circuit 131 of the information control apparatus 100 waits until accepting a setting instruction from the target person terminal 800 or the concerned party terminal 900 through the communication circuit 110 (S100: No).

If determining that a setting instruction has been accepted (S100: Yes), the acquiring circuit 131 acquires the objective of information from the target person terminal 800 or the concerned party terminal 900 from which the setting instruction has been accepted and outputs the objective to the setting circuit 132 (S101). Furthermore, the acquiring circuit 131 acquires a profile of the target person from the target person terminal 800 or the concerned party terminal 900 from which the setting instruction has been accepted and outputs the profile to the setting circuit 132 (S102).

Next, the setting circuit 132 stores the output profile in the model DB 122 (S103). Furthermore, the setting circuit 132 generates a human model with which the objective defined by the concerned party may be achieved and stores the human model in the model DB 122 to end the processing (S104).

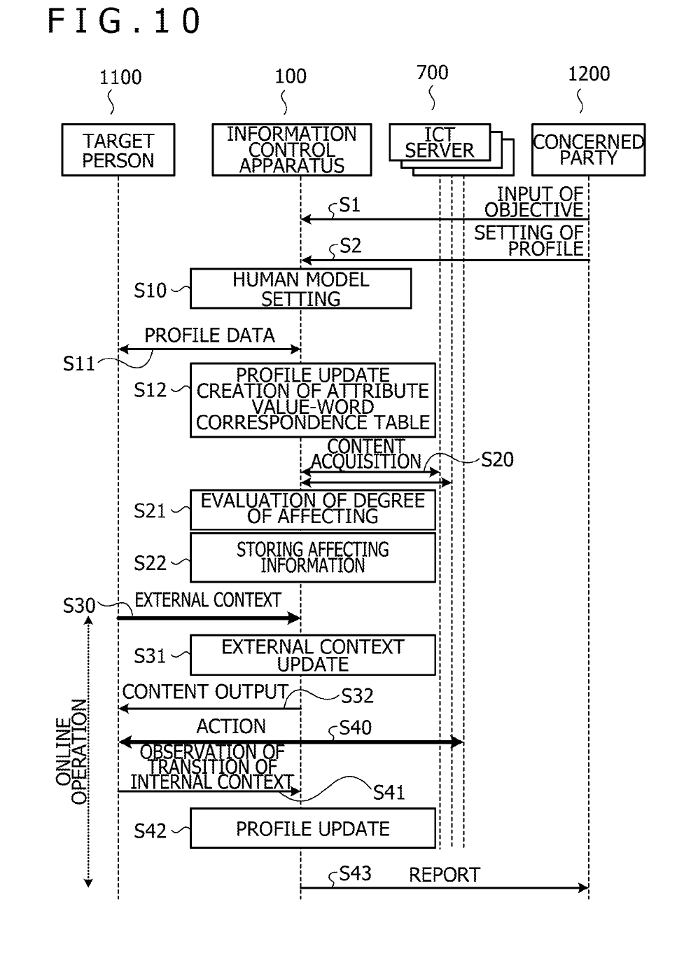

Next, information selection processing in the present embodiment will be described with respect to FIG. 12. FIG. 12 is a flowchart illustrating one example of the information selection processing in embodiment 1. First, the acquiring circuit 131 of the information control apparatus 100 waits until accepting information input from the ICT server 700 through the communication circuit 110 (S200: No).

If determining that information input has been accepted (S200: Yes), the acquiring circuit 131 outputs the accepted content to the determining circuit 134. The determining circuit 134 calculates the degree of affecting of the input content (S201). Then, the determining circuit 134 determines whether or not the degree of affecting is equal to or higher than a given threshold (S210).

If determining that the degree of affecting of the content is lower than the threshold (S210: Yes), the determining circuit 134 returns to S200. On the other hand, if determining that the degree of affecting of the content is equal to or higher than the threshold (S210: No), the determining circuit 134 refers to the model DB 122 and updates the internal context according to the degree of affecting (S211) to return to S200.

[Effects]

As described above, the information control apparatus in the present embodiment includes a memory that stores information relating to content and the request acquiring circuit that acquires information relating to a request specified by a third party different from the provision source of the content. Furthermore, the information control apparatus includes the determining circuit that determines whether or not to present the stored content to a user based on the request and the output circuit that outputs information relating to the content selected to be presented. This allows the third party other than the provision source to control the content to be provided to the user.

For example, it is said that there is a limit to the information perception ability of a human, and it is difficult to respond to information in some cases when the amount of received information becomes too large. The information control apparatus in the present embodiment may inhibit provision of content that does not match the request and reduce the amount of information presented to the target person because the third party other than the provision source may control the content to be provided to the target person.

Furthermore, the information control apparatus in the present embodiment refers to at least any one or plurality of profile, external context, and internal context and determines whether or not to present content to the user. The profile in the present embodiment represents the individuality of the user. The external context represents the environment surrounding the user. The internal context represents at least any of the inner sentiment and the physical condition of the user. Due to this, when content to be provided to the user is controlled, the individuality of the target person, the external environment, and the inner sentiment and the physical condition may be reflected.

For example, in the case of distributing advertisement content by using purchase history information, viewed commercial product information, and so forth of the target person, advertisement of a commercial product that has been already purchased by the target person and is unnecessary is repeatedly presented in some cases. The information control apparatus in the present embodiment determines that such advertisement content does “not affect” the internal context of the target person and thus may prevent presentation of the unnecessary advertisement content.

Furthermore, for example, even useful content regarding information on suspension of trains or the like will not be timely content when the target person has already reached the station and it is difficult to use a detour route. In such a case, if detecting that the present location, which is the external context of the target person, is the “station” instead of the “target person's house” or “place of work,” the information control apparatus in the present embodiment determines that the content is not timely and therefore presentation of the unnecessary content may be prevented.

Furthermore, based on the request defined by the concerned party (client), the information control apparatus in the present embodiment generates a human model that expresses the transition of the internal context of the user to set the internal context with which the request is readily realized. The information control apparatus determines whether or not to present content to the user based on whether or not the content leads to the transition to the internal context with which the request is readily realized. Due to this, information with which the internal context is readily changed toward realization of the request may be selected and provided to the target person.

Moreover, the information control apparatus in the present embodiment may change the presentation method of content according to any one or plurality of profile, external context, and internal context. This may provide content in a form suitable for attributes of the target person and the environment.

Furthermore, the information control apparatus acquires information relating to the request from the concerned party of the target person, for example. However, the configuration is not limited thereto and the information control apparatus may acquire the information relating to the request from the target person and may acquire the information relating to the request from both the target person and the concerned party of the target person. For example, the information control apparatus in the present embodiment may acquire the information relating to the request specified by at least either or both of the user and the concerned party of the user. This allows the target person to select information that matches the target person's own objective and receive provision.

### Embodiment 2

When the state of the internal context makes a transition based on the external context or information input, a certain law-like nature is found in the pattern of the transition. For example, the probability of the transition from the internal context of “I will go home early” represented in FIG. 7 directly to the internal context of “I go to the gym” is low and the transition is made through the internal context of “I want to exercise.”

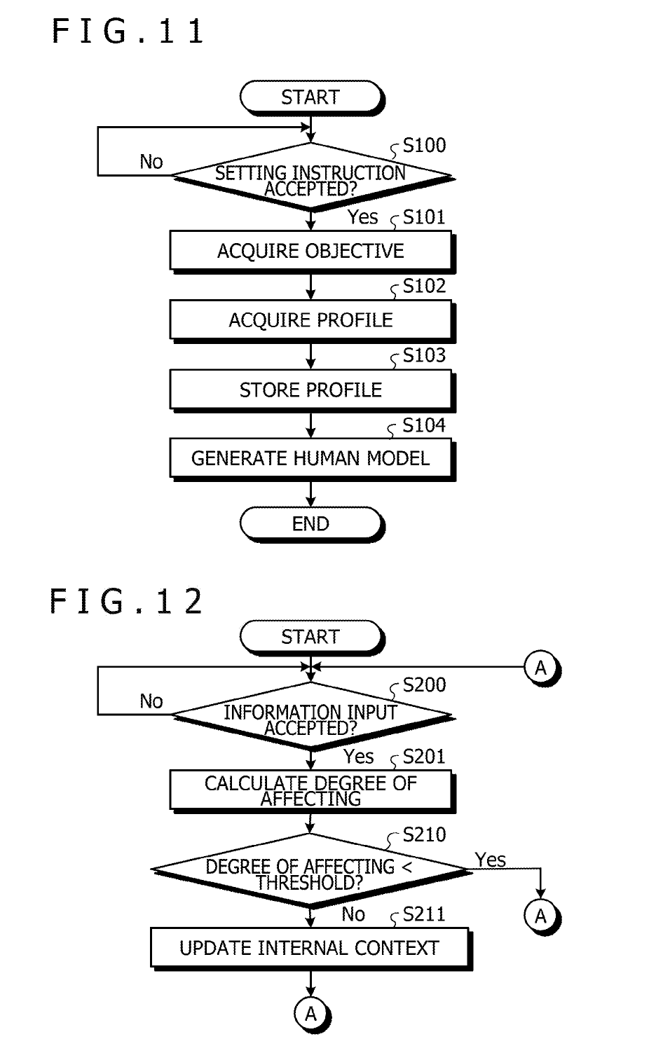

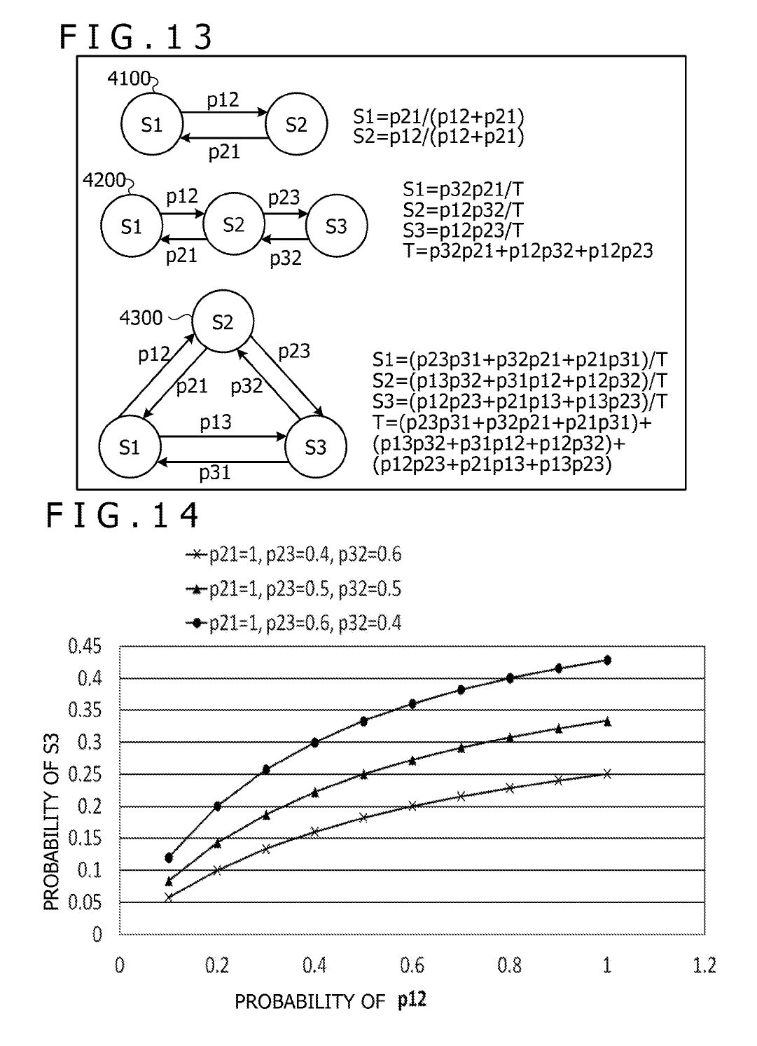

Therefore, in the present embodiment, the configuration that defines the probability of the transition of the internal context in a human model like that illustrated in FIG. 9 will be described with respect to FIG. 13 and FIG. 14. FIG. 13 is a diagram illustrating one example of the transition of the internal context in embodiment 2. In FIG. 13, “Sx” (x is an arbitrary natural number) represents the state probability at which the internal context remains at an internal context “x,” and “pxy” (y is an arbitrary natural number) represents the probability of a transition from the internal context “x” to an internal context “y”.

This transition probability “pxy” is an index that represents how much change in the internal context may be prompted when certain information is input, and providing the target person with information that raises the probability of remaining at the intended internal context is a main function of the information control apparatus 100.

In FIG. 13, a state transition diagram 4100 represents the case in which internal contexts included in a human model are two internal contexts of “1” and “2”. State transition diagrams 4200 and 4300 represent the case in which internal contexts included in a human model are three internal contexts of “1” to “3”. The state transition diagram 4200 represents the case in which the internal context does not make a transition from “1” to “3” unless passing through “2”. This is a transition diagram used for target advertisement or the like and is equivalent to the case in which it is inevitable to pass through “2” to make a transition to intended “3” when the internal contexts “1” to “3” are set as follows: “1: target person has not recognized the existence of the commercial product,” “2: target person has recognized the existence of the commercial product,” and “3: target person is interested in the commercial product.”

The other state transition diagram 4300 represents the case in which the internal context may make a transition from “1” to “3” without passing through “2” and, in this case, represents the case in which possibly a direct transition is made from “1,”“2,” and “3” to each other due to certain information. As described above, the internal contexts of observation targets are selected in such a manner that the sum of the respective state probabilities becomes “1.” For example, the selection is carried out in such a manner that the selected internal contexts form the whole set of sentiment relating to the objective. For example, only the internal contexts relevant for approximation to the objective are considered and the other internal contexts are not treated. Thereby, information for approximation to the intended internal context is narrowed down. The state transition diagram 4100 is the case in which “S3” does not exist in the state transition diagram 4300, and the state transition diagram 4200 is the case in which p13 and p31 are zero in the state transition diagram 4300. For example, it may be said that the state transition diagrams 4100 and 4200 are special cases of the state transition diagram 4300.

As illustrated in FIG. 13, the value obtained by summing up all of the state probabilities “Sx” is defined as “1”. Giving this condition makes it possible to calculate each state probability “Sx” by using the probability “pxy” of a transition from a specific internal context to another internal context in all cases.

Next, FIG. 14 is a diagram illustrating one example of transition probabilities of the internal context in embodiment 2. FIG. 14 represents change in the respective state probabilities “S3” when transition probabilities “pxy” are changed. As illustrated in FIG. 14, it turns out that the state probability “S3” becomes larger when the probability of “p23” is set larger relative to the probability of “p32” and when the probability of “p12” is brought closer to 1.

As above, the information control apparatus in the present embodiment reflects the state probability in each internal context and transition probabilities when setting a human model like that illustrated in FIG. 9.

[Effect]

As described above, the information control apparatus in the present embodiment sets a human model by using internal contexts whose sum of the state probabilities is 1 and transition probabilities among the internal contexts in association with presentation of information. The information control apparatus determines whether or not to present content to the user based on whether or not to prompt a transition to an internal context with which the request is readily realized or based on whether or not to increase the probability of a stay at this internal context. This may select and provide the content in a form having more conformity with the actual form of the transition of the internal context.

### Embodiment 3

It is conceivable that, when it is determined whether or not content “affects” the internal context of the target person, attention is paid to terms included in this content. Furthermore, the term often seen or input by the target person will have a high possibility of “affecting” the internal context of the target person.

Moreover, in the above-described respective embodiments, the configuration in which the information control apparatus 100 acquires content from the ICT server 700 is described. However, the configuration is not limited thereto and the information control apparatus may generate content. At this time, the information control apparatus may prompt a change in the internal context of the target person by generating content including a term that “affects” the internal context of the target person like ones described above.

Therefore, in the present embodiment, with attention paid to terms included in content, description will be made about a configuration that determines whether or not to output content to the target person and a configuration that generates content to be provided to the target person.

[Functional Blocks]

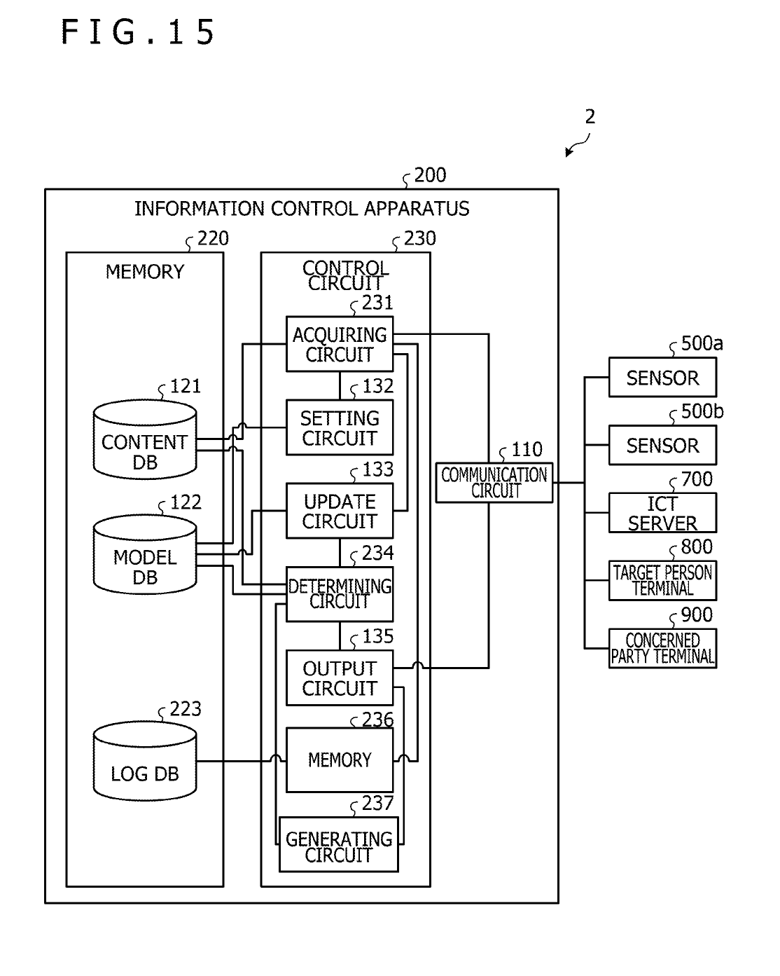

FIG. 15 is a diagram illustrating one example of an information control system in embodiment 3. An information control system 2 illustrated in FIG. 15 includes information control apparatus 200, the sensors 500a and 500b, the ICT server 700, the target person terminal 800, and the concerned party terminal 900. In the following embodiment, the same part as a part illustrated in FIG. 8 is given the same symbol and overlapping description is omitted.

The information control apparatus 200 in the present embodiment includes the communication circuit 110, a memory 220, and a control circuit 230. The memory 220 stores various kinds of data and so forth such as a program executed by the control circuit 230, for example. Furthermore, the memory 220 includes a log DB 223 in addition to the content DB 121 and the model DB 122. The memory 220 corresponds to semiconductor memory elements such as RAM, ROM, and flash memory and storing apparatus such as an HDD.

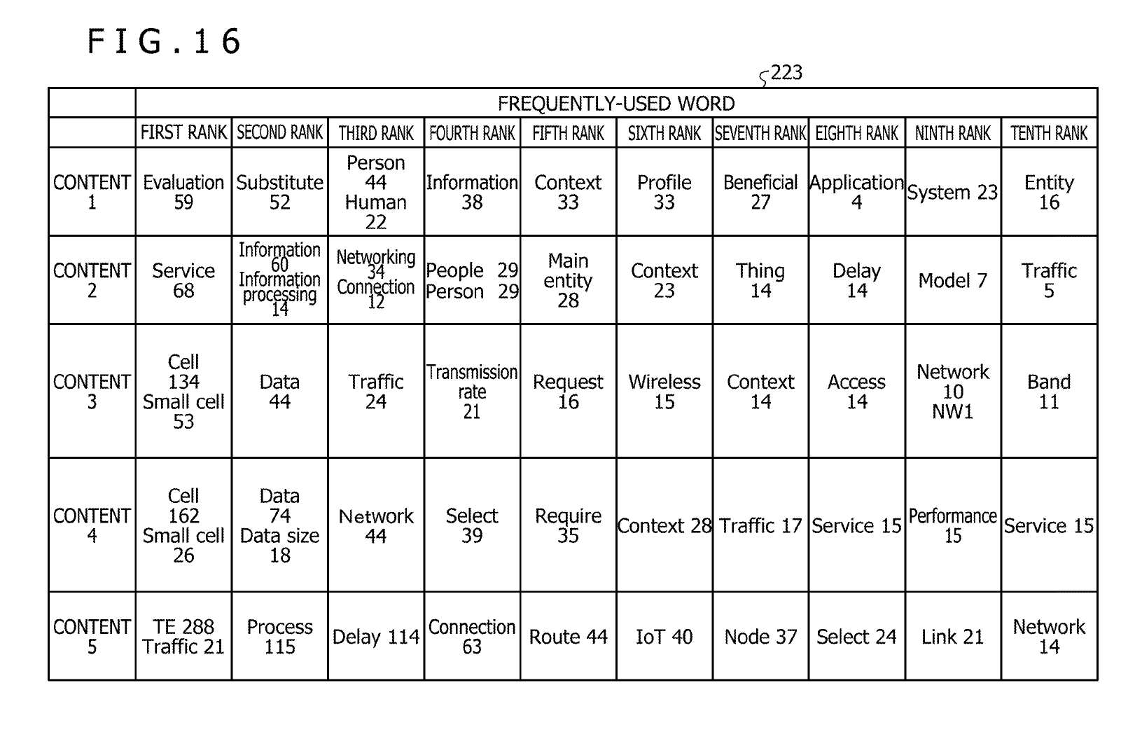

The log DB 223 stores terms included in pieces of content included in Web sites or the like viewed by the target person and pieces of content such as blogs input by the target person. FIG. 16 is a diagram illustrating one example of the log DB 223 in embodiment 3. As represented in FIG. 16, regarding each piece of content, the log DB 223 stores terms included in the content in decreasing order of the appearance frequency in this content. The information stored in the log DB 223 is input by an acquiring circuit 231 to be described later, for example.

Referring back to FIG. 15, the control circuit 230 is a processing unit responsible for overall processing of the information control apparatus 200. The control circuit 230 is implemented through execution of a program stored in internal storing apparatus by a CPU, MPU, or the like with use of a RAM as a work area, for example. Furthermore, the control circuit 230 may be implemented by an integrated circuit such as an ASIC or FPGA, for example.

The control circuit 230 includes the acquiring circuit 231, the setting circuit 132, the update circuit 133, a determining circuit 234, the output circuit 135, a memory 236, and a generating circuit 237. The acquiring circuit 231, the determining circuit 234, the memory 236, and the generating circuit 237 are also one example of an electronic circuit included in a processor and one example of a process executed by the processor.

The acquiring circuit 231 further acquires terms included in content viewed or input by the target person in addition to information on content, information relating to the request of the target person, information relating to the profile, and sensor information. The acquiring circuit 231 acquires, through the communication circuit 110, content downloaded in the target person terminal 800 and content input through the target person terminal 800, for example. The acquiring circuit 231 extracts terms included in each acquired piece of content and associates each piece of content with the appearance frequency of these terms to store each piece of content and the appearance frequency in the log DB 223.

The memory 236 identifies terms that “readily affect” the internal context. For example, the memory 236 refers to the log DB 223 and identifies terms whose appearance frequency is high. At this time, the memory 236 may carry out “weighting” on the terms whose appearance frequency is high so as to indicate that these terms are terms that “readily affect” the internal context. The memory 236 outputs information relating to the weighting to the determining circuit 234.

The memory 236 may create a correspondence table of the weighted term, the profile, and the external context or the internal context. For example, as illustrated in the above-described FIGS. 3A, 3B, and 3C, the memory 236 may create a correspondence table of attribute values of the profile and “readily-affecting” terms in the right column in advance.

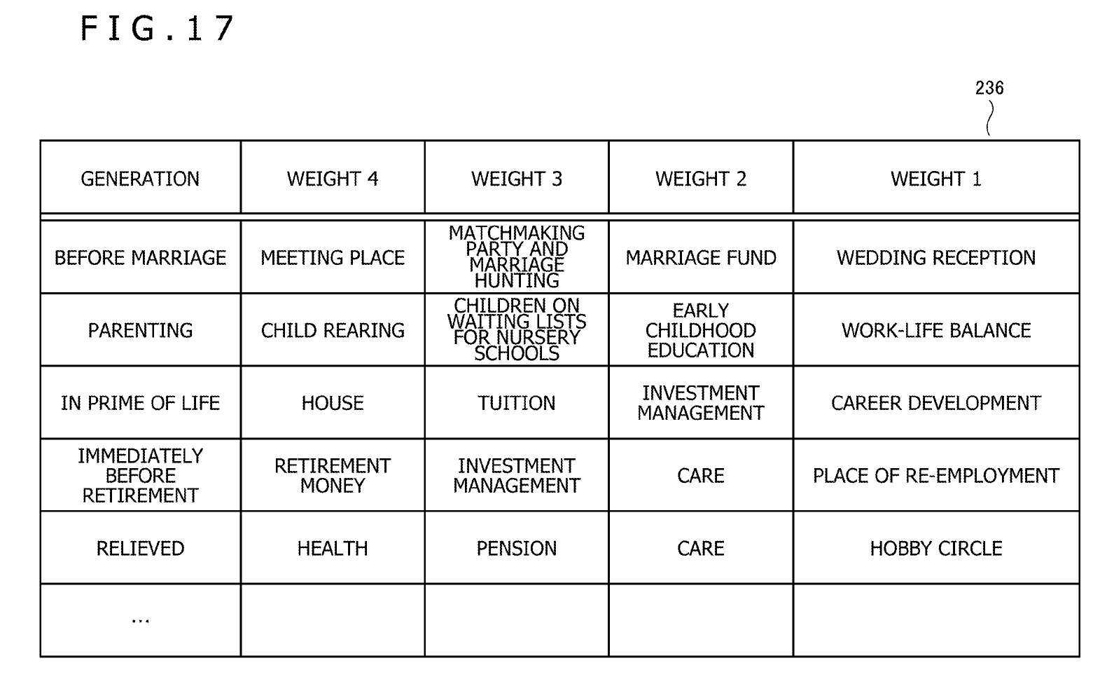

Furthermore, when carrying out weighting on terms, the memory 236 may change the weight according to the profile of the target person. At this time, the memory 236 may generate a correspondence table of terms and the weight like one illustrated in FIG. 17. FIG. 17 is a diagram illustrating one example of the relationship between profile attributes and readily-affecting words in embodiment 3. In FIG. 17, it is indicated that, when the value of the weight is larger, the corresponding term is a term that “more readily affects” the internal context.

As represented in FIG. 17, the weight of the term may be changed according to a profile attribute such as “generation,” for example. For example, when the target person is in the generation “before marriage,” the weight of terms relating to marriage, such as “meeting place,” may be raised. Furthermore, regarding the target person in the “parenting” generation, the weight of terms relating to parenting, such as “child rearing” and “children on waiting lists for nursery schools,” may be raised whereas the weight of terms relating to marriage may be lowered.

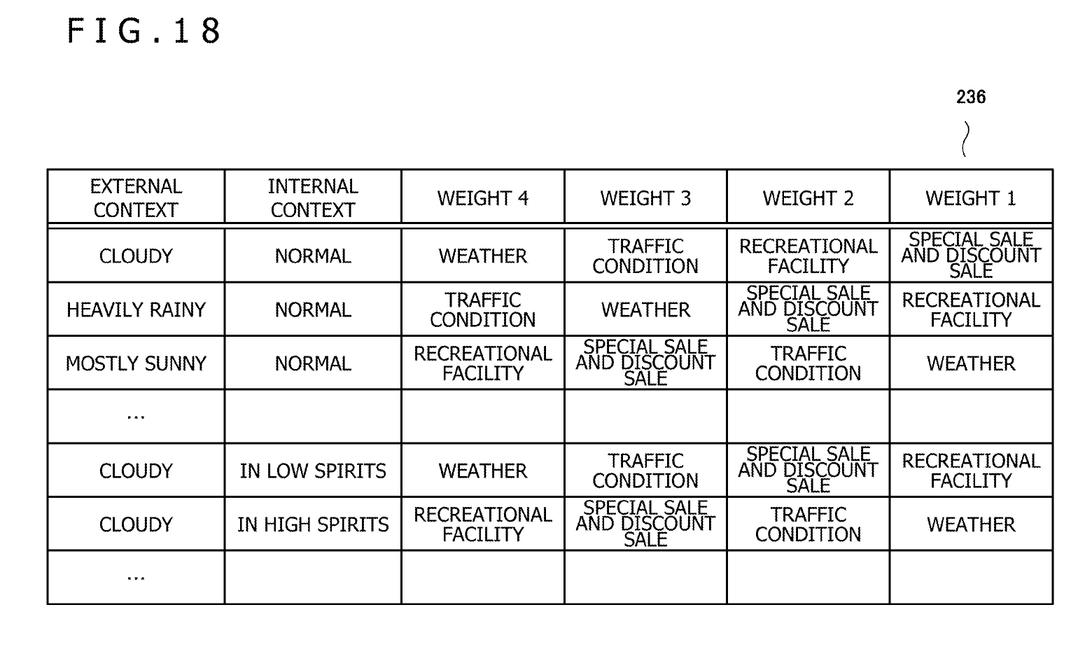

Furthermore, when carrying out weighting on terms, the memory 236 may change the weight according to the profile, external context, or internal context of the target person. At this time, the memory 236 may generate a correspondence table of terms and the weight like one illustrated in FIG. 18 similarly to the correspondence table illustrated in FIG. 17. FIG. 18 is a diagram illustrating one example of the relationship between contexts and readily-affecting words in embodiment 3. For example, if the external context is “mostly sunny,” the memory 236 may raise the weight of terms relating to going out, such as “recreational facility” and “special sale and discount sale.” Furthermore, if the external context is “heavy rain,” the possibility that the target person refrains from going out is high. Thus, the memory 236 may lower the weight of terms relating to going out and raise the weight of terms such as “traffic condition” and “weather.”

Similarly, in the case of an internal context of “in low spirits,” the memory 236 may lower the weight of terms relating to going out because the possibility that the target person refrains from going out is high. Furthermore, in the case of an internal context of “in high spirits” conversely, the memory 236 may raise the weight of terms relating to going out.

Referring back to FIG. 15, the determining circuit 234 refers to the weight of terms in addition to a human model and determines whether or not to output content to the target person. For example, the determining circuit 234 calculates the total of the weights of terms included in this content as the “degree of affecting” and determines whether or not this degree of affecting is equal to or higher than a given threshold. If the “degree of affecting” is equal to or higher than the given threshold, the determining circuit 234 determines to output this content to the target person. Furthermore, the determining circuit 234 may output the determination result including the weight of the terms to the generating circuit 237.

The generating circuit 237 generates content to be provided to the target person. The generating circuit 237 generates content that “readily affects” the internal context of the target person by using the weight of terms input from the determining circuit 234, for example. The generating circuit 237 outputs the generated content to the output circuit 135.

For example, the generating circuit 237 refers to the log DB 223 like that represented in FIG. 16 and identifies that words whose appearance frequency is high in the log DB 223 are “traffic,”“context,”“delay,”“cell,” and “process.” Then, the generating circuit 237 uses these words whose appearance frequency is high as words that enhance the probability of a transition to or a stay at an internal context with which the request is readily realized, and generates content of text including these words or the like.

[Effects]

As described above, the information control apparatus in the present embodiment identifies at least one term that prompts a transition to an internal context or enhances the probability of a stay at this internal context based on the profile. The information control apparatus calculates the degree of influence of content on the internal context based on the appearance frequency of terms included in information and determines whether or not to present the content to the user by using this degree of influence. This may select and provide content that “more readily affects” the internal context of the target person.

Furthermore, the information control apparatus identifies terms whose appearance frequency is high in information created or viewed by the user and generates a correspondence table in which weighting is carried out according to the appearance frequency of the term. Due to this, terms that “readily affect” the internal context of the target person may be identified and content including these terms may be selected and provided.

In addition, the information control apparatus changes the weight of terms according to a difference in the state of at least any of profile, external context, and internal context. This may select and provide content including terms that more “readily affect” the internal context according to the situation.

Moreover, the information control apparatus generates content by using at least one term that prompts a transition to an internal context or enhances the probability of a stay at this internal context and stores the content in the memory. This may generate and provide content that “readily affects” the internal context of the target person.

### Embodiment 4

A number of human models are not necessarily one per target person and it is also possible to define plural human models regarding requests and objectives defined by the concerned party. Furthermore, regarding a certain request or objective of one target person, when the profile or context differs, how information affects the target person also differs. Therefore, an implementation method in which plural human models are set according to the profile or context and are used differently according to the profile or context is also conceivable.

Furthermore, description is made about the configuration in which change in the internal context is detected by using sensor information acquired from the sensor 500, for example. According to the detected change in the internal context, the human model may be changed or the applied human model may be switched.

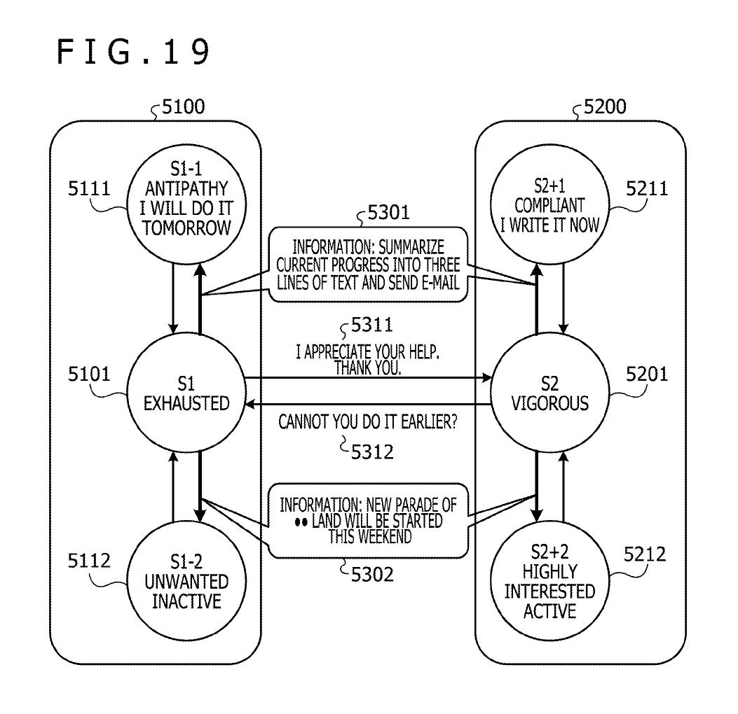

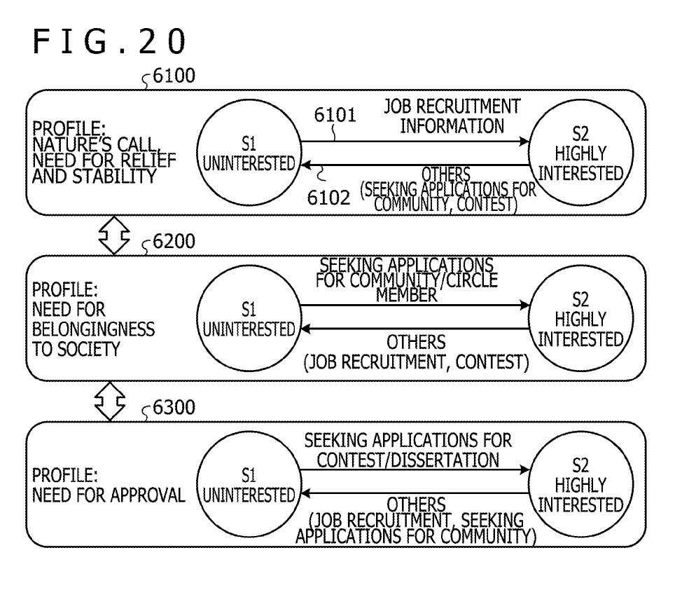

Changing or switching of the human model in the present embodiment will be described by using FIG. 19 and FIG. 20. FIG. 19 is a diagram illustrating one example of the relationship between a difference in the internal context and the transition based on information input in embodiment 4. FIG. 19 represents a difference in the transition of the internal context when the information input is made between the case in which the internal context is “S1: exhausted” 5101 and the case in which the internal context is “S2: vigorous” 5201.

As illustrated in FIG. 19, for example, if information input 5301 relating to business, “summarize the current progress into three lines of text and send an e-mail,” is made, when the internal context is S1, the internal context negatively makes a transition to “S1−1: I will do it tomorrow” 5111. On the other hand, when the internal context is S2, the internal context positively makes a transition to “S2+1: I write it now” 5211. Furthermore, if information input 5302 relating to leisure like “new parade of ●● land will be started this weekend” is made, when the internal context is S1, the internal context negatively makes a transition to “S1−2: unwanted” 5112. On the other hand, when the internal context is S2, the internal context positively makes a transition to “S2+2: highly interested” 5212.

A transition will be made between the internal contexts 5101 and 5201 due to other information inputs 5311 and 5312 regarding business, for example. For example, if the positive information input 5311 is “I appreciate your help. Thank you.” is made, the internal context will make a transition from 5101 to 5201. Conversely, if the negative information input 5312 like “cannot you do it earlier?” is made, the internal context will make the reverse transition from 5201 to 5101.

As above, the information control apparatus in the present embodiment generates different human models 5100 and 5200 according to the difference in the internal context and thereby may predict the transition of the internal context in more conformity with the sentiment and physical condition of the target person.

In FIG. 19, a difference in the transition of the internal context based on a difference in the internal context is described. The transition of the internal context will differ also based on a difference in the profile, for example. The difference in the profile appears as a difference in the hierarchical structure of needs, for example. Thus, a difference in the stage of needs based on difference in the profile and a change in the internal context will be described here.

FIG. 20 is a diagram illustrating one example of the relationship between the stage of needs and the transition of the internal context. In FIG. 20, for example, a human model 6100 represents the case in which the target person is at such a stage that “nature's call” and “need for relief and stability” are not satisfied, such as the case in which an attribute of the profile is “out of work.” In such a case, the internal context will make a transition to “S2: highly interested” in response to information input 6101 relating to income, such as “job recruitment information,” whereas no movement from an internal context of “S1: uninterested” will be made regarding other kinds of information input 6102, for example. On the other hand, if the stage of needs corresponding to an attribute of the profile has grown to “need for belongingness to the society,” “need for approval,” or the like, the transition of the internal context in response to information input also differs for each case. No reaction is made to “seeking applications for recruitment” whereas movement to the internal context of “S2: highly interested” is made due to content including information of “seeking applications for a circle member” or “seeking applications for contest.” Thus, the information control apparatus in the present embodiment may apply different human models like human models 6200 and 6300.

As above, the information control apparatus in the present embodiment may predict the transition of the internal context in more conformity with an attribute of the target person by generating the different human models 6100 and 6200 according to a difference in the profile.

Moreover, the information control apparatus may switch the human model according to a difference in the external context in addition to a difference in the profile and a difference in the internal context. For example, the information control apparatus may use human models different from each other between when the target person is “on duty” and when the target person is “on holiday” or between when the weather is “sunny” or when the weather is “rainy.”

The information control apparatus in the present embodiment may switch the human model when detecting a change in the internal context by using sensor information like that described in embodiment 1, or the like. Furthermore, the information control apparatus may update the human model when detecting change in the internal context different from the transition of the internal context assumed in the human model.

For example, in the case in which information input regarding which the transition probability pxy of the internal context is “0.3” is made to an agent of 100 target persons, the information control apparatus determines that the transition of the internal context has been detected regarding “20” target persons. In this case, the information control apparatus may raise the accuracy of the human model by changing this transition probability pxy of the internal context to “0.2.” Furthermore, the information control apparatus may further change the above-described weight of terms in addition to the transition probability of the internal context.

[Effects]

As described above, the information control apparatus in the present embodiment generates plural human models and switches the human model used for determination based on at least either of the state of the external context and the state of the internal context. This may select the human model suitable for the present attribute of the target person, the external environment, and the sentiment and the physical condition. Thus, it becomes possible to select information or content to be provided in such a manner as to enhance the state probability of the intended internal context.

Furthermore, the information control apparatus in the present embodiment updates the human model by observing the transition of the internal context in association with a presentation of content and estimating or updating the transition probability of the internal context regarding each piece of presented content. This may optimize the human model in conformity with the actual transition of the internal context of the target person.

Moreover, the information control apparatus in the present embodiment associates the human model with the external context to store the human model and the external context, and switches the human model used for determination according to the state of the external context observed at the time of acquisition of content. This may select the human model most suitable for the external context.

### Embodiment 5

Although embodiments of the present disclosure are described thus far, techniques of the present disclosure may be carried out in various different forms besides the above-described embodiments. For example, the above-described human model is what is obtained by modeling the thought and behavior of a person in such a manner that change in the internal context of the “person” as the target is employed as the core. However, the target of the human model in the present embodiment is not limited to the “individual.” For example, a configuration may be employed in which the information control apparatus generates a human model for a corporation for predicting purchase behavior or the like of a company, school, or the like and functions as an agent (substitute) of this company, school, or the like.

For example, when a company that desires to improve the ordinary profit carries out several measures, the vision, the mission, and the number of employees of the company are selected as the profile. Furthermore, the technology trend, the social system, and movement of competitors are selected as the external context and the ordinary profit is selected as the internal context measures as candidates are employed as the content. The content and information are candidates for measures. This makes it possible to quantitatively infer a measure that will enhance the ordinary profit by inferring the effect on the ordinary profit selected as the internal context.

Moreover, it is also conceivable that this human model is applied to machines and devices such as automobiles and robots. For example, as a model of an automobile, the performance of the automobile, such as the fuel consumption, is selected as the profile. Furthermore, the weather and the traffic conditions are selected as the external context and the remaining fuel level is selected as the internal context. If many conceivable routes from the point of departure to the destination are applied instead of the content and information described thus far, the remaining fuel level may be derived regarding each route and which route allows guiding (navigation) along which the fuel may be saved at the highest degree may be inferred.

Furthermore, although the example in which the information control apparatus 100 is implemented on a server computer or cloud, for example, is described, the configuration is not limited thereto and the information control apparatus 100 may be implemented in the target person terminal 800 or the like. In this case, the output circuit 135 of the information control apparatus 100 may output content through a screen, speaker, and so forth operated by the target person terminal 800, for example.

[System]

Furthermore, processing procedures, control procedures, concrete names, information including various kinds of data and parameters represented described above and the drawings may be arbitrarily changed unless otherwise noted.

Furthermore, the respective constituent elements of the respective pieces of apparatus that are diagrammatically represented are functionally conceptual and do not necessarily have to be configured as diagrammatically represented physically. For example, concrete forms of distribution and integration of the respective pieces of apparatus are not limited to the diagrammatically-represented forms. For example, all or part of the respective pieces of apparatus may be configured to be distributed or integrated functionally or physically in an arbitrary unit according to various kinds of loads, the status of use, and so forth. Moreover, all or an arbitrary part of the respective processing functions carried out in the respective pieces of apparatus may be implemented by a CPU and a program analyzed and executed in this CPU or be implemented as hardware based on wired logic.

[Program]

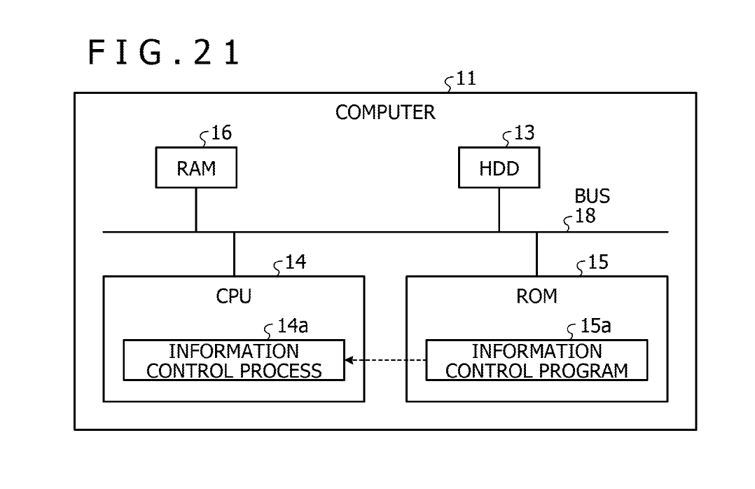

In the above-described embodiments, the case in which various kinds of processing are implemented based on hardware logic is described. However, various kinds of processing may be implemented by executing a program prepared in advance by a computer. Therefore, in the following, one example of a computer that executes an information control program having the like functions as the information control apparatus 100 represented in the above-described embodiments will be described by using FIG. 21. FIG. 21 is a diagram illustrating one example of the computer that executes the information control program. Although description will be made about the information control apparatus 100 in embodiment 1 in the following, the pieces of information control apparatus in the other embodiments may also be implemented by the like configuration.

As illustrated in FIG. 21, a computer 11 as the information control apparatus 100 includes an HDD 13, a CPU 14, a ROM 15, a RAM 16, and so forth coupled by a bus 18.

In the ROM 15, the information control program that exerts the like functions as the information control apparatus 100 represented in the above-described embodiment, for example, an information control program 15a, is stored in advance as illustrated in FIG. 21. The information control program 15a may be integrated or distributed as appropriate similarly to the respective constituent elements of the information control apparatus 100 illustrated in FIG. 8.

Furthermore, the CPU 14 reads out the information control program 15a from the ROM 15 and executes the information control program 15a. Thereby, the information control program 15a functions as an information control process 14a as illustrated in FIG. 21. The information control process 14a corresponds to the acquiring circuit 131, the setting circuit 132, the update circuit 133, the determining circuit 134, and the output circuit 135 illustrated in FIG. 8. Moreover, the CPU 14 executes the information control program 15a based on data recorded in the RAM 16 (for example, measurement value data).

The above-described information control program 15a does not necessarily need to be stored in the ROM 15 from the beginning. For example, each program may be stored in a “portable physical medium” such as a flexible disc (FD), compact disc (CD)-ROM, digital versatile disc (DVD), magnetooptical disc, or integrated circuit (IC) card inserted in the computer 11. Furthermore, each program may be stored in a “physical medium for fixation,” such as an HDD, provided inside or outside the computer 11, for example. Moreover, each program may be stored in “another computer (or server)” or the like coupled to the computer 11 via a public line, the Internet, a local area network (LAN), a wide area network (WAN), or the like, for example. Then, the computer 11 may read out each program from this computer and execute each program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information control apparatus comprising:
a memory configured to store information relating to content;
an acquiring circuit configured to acquire information relating to a request specified by a third party different from an original source of the content;
a determining circuit configured to determine whether or not to present stored content to a user based on the request; and
an output circuit configured to output information relating to content selected to be presented.

2. The information control apparatus according to claim 1, wherein
the determining circuit refers to at least any one or a plurality of a profile that represents individuality of the user, an external context that represents an environment surrounding the user, and an internal context that represents at least either of internal sentiment or a physical condition of the user, and determines whether or not to present the content to the user.

3. The information control apparatus according to claim 2, wherein
the output circuit changes a presentation method of the content according to any one or a plurality of the profile, the external context, and the internal context.

4. The information control apparatus according to claim 3, further comprising:
a setting circuit configured to generate a human model that expresses a transition of the internal context of the user based on the request or both of the request and the profile and set an internal context with which the request is realized,
wherein the determining circuit determines whether or not to present the content to the user based on whether or not the content leads to a transition to the internal context with which the request is realized.

5. The information control apparatus according to claim 4, wherein
the setting circuit sets the human model by using internal contexts whose sum of state probabilities is 1 and transition probabilities among the internal contexts in association with a presentation of the information, and
the determining circuit determines whether or not to present the content to the user based on whether or not to prompt the transition to the internal context with which the request is realized or whether or not to enhance a probability of a stay at the internal context.

6. The information control apparatus according to claim 5, further comprising:
a memory configured to identify at least one term that prompts the transition to the internal context with which the request is realized or enhances the probability of the stay at the internal context based on the profile,
wherein the determining circuit calculates a degree of influence of the content on the internal context based on appearance frequency of the term included in the information and determines whether or not to present the content to the user by using the degree of influence.

7. The information control apparatus according to claim 6, wherein
the memory identifies a term whose appearance frequency is high in information created or viewed by the user and generates a correspondence table in which weighting is carried out according to the appearance frequency of the term.

8. The information control apparatus according to claim 6, wherein
the memory changes a weight of the term according to a difference in at least any of an attribute of the profile, a state of the external context, and a state of the internal context.

9. The information control apparatus according to claim 6, further comprising:
a generating circuit configured to generate content by using at least one term that prompts the transition to the internal context with which the request is realized or enhances the probability of the stay at the internal context with which the request is realized, and store the content in the memory.

10. The information control apparatus according to claim 4, wherein
the setting circuit generates a plurality of the human models, and
the determining circuit switches a human model used for the determination based on at least either of the state of the external context and the state of the internal context.

11. The information control apparatus according to claim 10, wherein
the setting circuit updates the human model by observing the transition of the internal context in association with presentation of the content and estimating or updating a transition probability of the internal context regarding each piece of the content presented.

12. The information control apparatus according to claim 10, wherein
the setting circuit associates the human model with the external context to store the human model and the external context, and
the determining circuit switches the human model used for the determination according to the state of the external context observed at time of acquisition of the content.

13. The information control apparatus according to claim 1, wherein
the acquiring circuit acquires information relating to the request specified by at least either or both of the user and a concerned party of the user.

14. An information control system comprising:
an information control apparatus including:
a memory configured to store information relating to content,
a request acquiring circuit configured to acquire information relating to a request specified by a third party different from an original source of the content,
a determining circuit configured to determine whether or not to present stored content to a user based on the request,
a transmitting circuit configured to transmit information relating to content selected to be presented to the terminal; and
a terminal, coupled to the information control apparatus, including
an output circuit configured to output the information that is transmitted from the information control apparatus and relates to the content.

15. An information control method for an information control apparatus including a memory that stores information relating to content and a processor coupled to the memory, that executes a process, the process comprising:
acquiring information relating to a request specified by a third party different from an original source of the content;
determining whether or not to present stored content to a user based on the request; and
outputting information relating to the content selected to be presented.

16. A non-transitory computer-readable recording medium having stored therein a program for causing a computer to execute a process, the process comprising:
acquiring information relating to a request specified by a third party different from an original source of the content;
determining whether or not to present stored content to a user based on the request; and
outputting information relating to the content decided to be presented.

17. An information control apparatus comprising:
a memory storing instructions; and
a processor that executes the instructions to perform a process, the process including:
acquiring information relating to a request from a third party, the information provided in a profile of a user,
determining whether the data affects the information in the profile,
transitioning content in the information when a determination is made that the data affects the information, and
outputting content provided by a content source to the user based on the request.

18. The information control apparatus according to claim 17, wherein the profile comprises internal factors of the user including any of demographics, mood, personality, abilities, and employment and external factors of the user including any of location, current time, current activity, and an emergency situation.

19. The information control apparatus according to claim 17, further comprising determining whether a degree of affecting the information is equal to or higher than a predetermined threshold.
